(19) United States
(12) Patent Application Publication
(10) Pub. No.: US 2010/0320919 A1
(43) Pub. Date: Dec. 23, 2010

(54) METHOD AND APPARATUS FOR MODIFYING PIXELS BASED AT LEAST IN PART ON AMBIENT LIGHT LEVEL

(75) Inventors: Sam Gough, Northants (GB); Nigel Richardson, Surrey (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/488,712

(22) Filed: Jun. 22, 2009

(51) Int. Cl. H05B 37/02

(52) U.S. Cl. 315/158

(57) ABSTRACT

In accordance with an example embodiment of the present invention, an apparatus configured to detect an ambient light level and modify one or more pixels to display in a power conserving manner based at least in part on the ambient light level.

### TECHNICAL FIELD

The present application relates generally to modifying pixels based at least in part on ambient light level.

### BACKGROUND

Today networks, such as the Internet, are widely used for viewing content. Users can view content on any number of devices. In this way, a user has device options for viewing content.

### SUMMARY

Various aspects of examples of the invention are set out in the claims.

According to a first aspect of the present invention, an apparatus configured to detect an ambient light level and modify one or more pixels to display in a power conserving manner based at least in part on the ambient light level.

According to a second aspect of the present invention, a method, comprises detecting an ambient light level; and modifying one or more pixels to display in a power conserving manner based at least in part on the ambient light level.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting display on an electronic device operating in accordance with an example embodiment of the invention;

FIG. 3 is a flow diagram illustrating an example method for modifying one or more pixels in accordance with an example embodiment of the invention;

FIG. 4 is a flow diagram illustrating an example method for displaying one or more pixels in accordance with an example embodiment of the invention;

FIG. 5A is a block diagram depicting an example display in accordance with an example embodiment of the invention;

FIG. 5B is a block diagram depicting another example display in accordance with an example embodiment of the invention;

FIG. 6A is a block diagram depicting yet another example display in accordance with an example embodiment of the invention; and

FIG. 6B is a block diagram depicting still another example display in accordance with an example embodiment of the invention.

### DETAILED DESCRIPTION OF THE DRAWINGS

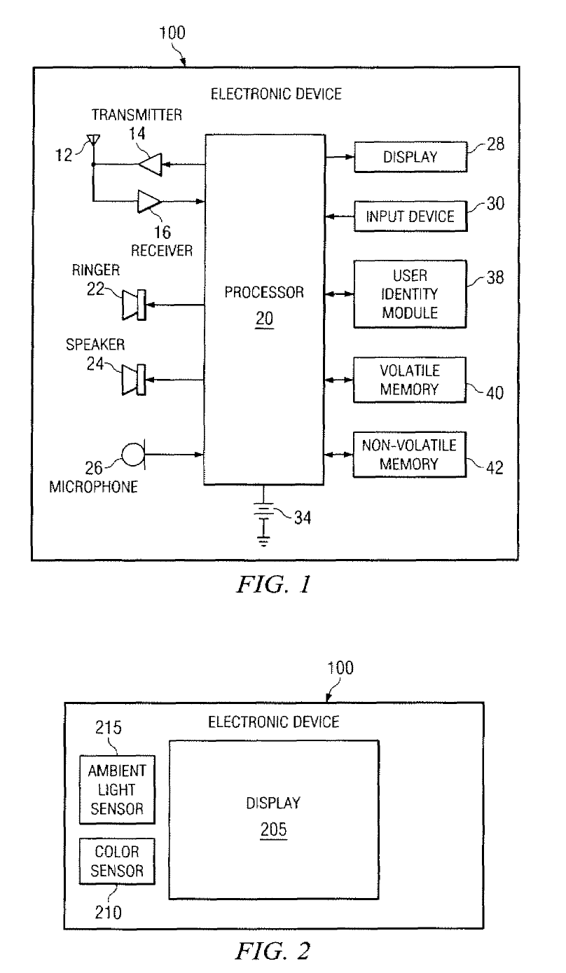

An example embodiment of the present invention and its potential advantages are understood by referring to FIGS. 1 through 6B of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, a liquid crystal display, an electronic ink, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

FIG. 2 is a block diagram depicting display on an electronic device 100 operating in accordance with an example embodiment of the invention.

In an example embodiment, the electronic device 100 comprises a display 205, one or more color sensors 210, one or more ambient light sensors 215, and/or the like. In an embodiment, the display 205 is a transparent organic light-emitting diode display. An organic light emitting diode (OLED), also known as a light emitting polymer (LEP) and organic electro luminescence (OEL), is a light emitting diode (LED) whose emissive electroluminescent layer is composed of a film of organic compounds. The layer typically comprises a polymer substance that allows suitable organic compounds to be deposited. The organic compounds are deposited in rows and columns onto a flat carrier by a simple “printing” process. A resulting matrix of pixels can emit light of different colors. Such techniques may be employed in the electronic device 100, television screens, computer displays, small, portable system screens, such as mobile phones, advertising, information, and/or the like. OLEDs can also be used in light sources for general space illumination, and large-area light-emitting elements. OLEDs typically emit less light per area than inorganic solid-state based LEDs which are usually designed for use as point-light sources.

In an example embodiment, the one or more ambient light sensors 215 detect lighting to modify brightness. In an example embodiment, the one or more ambient light sensors 215 detect the amount of light in an environment of, for example, the electronic device 100. In an embodiment, the one or more ambient light sensors 215 are based at least in part on one of photoresistors, photodiodes, phototransistors, and/or the like. In an embodiment, the one or more ambient light sensors 215 are used to determine at what level the pixels of the transparent display should be illuminated. In lower light levels the illumination of the pixels could be reduced thus contributing to power saving.

In an embodiment, photoresistors are two terminal components, where the resistance between these terminals varies depending on the amount of light striking the component face. Photo resistors are generally the least expensive light detecting option and have a relatively slow milliseconds response time. In an embodiment, photodiodes are also two terminal components. Photodiodes are capable of developing a voltage across the terminals that is proportional to the amount of light striking the sensor surface. In an embodiment, phototransistors are two terminal transistors. The third terminal, the base in a bipolar transistor or the gate in a field-effect transistor, is replaced by the light collecting surface. The amount of light striking the surface supplies the base (or gate) current and regulates the amount of current that can flow from the collector to emitter (or source to drain). Phototransistors typically have a quick, e.g., nanoseconds, response time. In an embodiment, the one or more ambient light sensors 215 are “Combo” sensors, which combine two silicon PN photodiodes and a phototransistor. The photodiodes measure the intensity and direction of sunlight directed at the electronic device 100 adjusting the display 205 for optimum user interaction.

In an example embodiment, the one or more color sensors 210 are used to determine whether contrast should be modified. In an example embodiment, contrast is the difference between the illuminated pixels on the display 205 and the background, e.g., behind the display 205. In an example embodiment, the one or more color sensors 210 may be a bayer sensor, foveon X3 sensor, 3CCD sensor, and/or the like. In an embodiment, the bayer sensor uses a color filter array such as a bayer filter that passes red, green, or blue light to selected sensels, or pixels, forming interlaced grids sensitive to red, green, and blue. The image is then interpolated using a demosaicing algorithm. In an embodiment, the foveon X3 sensor uses an array of layered sensors where every pixel contains three stacked sensors sensitive to the individual colors. In an embodiment, the 3CCD uses at least three discrete image sensors, with the color separation done by a dichroic prism. Regardless of the type of color sensor, the one or more color sensors 210 determine the displayed pixel color. Using the pixel color, the display 205 displays a pixel with appropriate contrast to the displayed pixel color. In this way, contrast is improved. It should be understood that appropriate contrast may be pre-defined, selected by a user, or dynamically determined.

In an example embodiment, the electronic device 100 is configured to detect an ambient light level using. In an embodiment, the electronic device 100 uses the one or more ambient light sensors 215 to determine the ambient light level. Further, the electronic device 100 is configured to modify one or more pixels to display in a power conserving manner based at least in part on the ambient light level. For example, the electronic device 100 displays pixels based at least in part on the brightness on the display 205. In an alternative embodiment, the display 205 may display the pixels.

In an example embodiment, the electronic device 100 uses the one or more color sensors 210 to determine the contrast. In an embodiment, the one or more color sensors 210 detect a background, for example, behind the electronic device 100 by emitting a known light and measuring what is reflected from the background. In an alternative embodiment, the one or more color sensors 210 detect a background of the electronic device using a rear facing camera sensor. In an embodiment, the camera may be part of the electronic device 100. In an alternative embodiment, the camera may be a low power and/or low resolution camera dedicated to color sensing for distant surfaces/objects. In an embodiment, a proximity sensor may be used to determine which color sensor is to be used. In an embodiment, a proximity sensor may emit infra-red light to detect distance.

In an embodiment, the electronic device 100 is configured to modify one or more pixels to display in a power conserving manner based at least in part on the contrast. For example, the electronic device 100 displays pixels with an appropriate contrast based at least in part on the contrast currently displayed. In an alternative embodiment, the display 205 may display the pixels.

In an example embodiment, the display 205 is a transparent display configured to detect an ambient light level. Further, transparent display may be is presented in such a manner so as to provide contrast without using power. By modifying, e.g., displaying, pixels on the transparent display, the transparent display or the background below the display 205 is used as the background. In such a case, the transparent color is presented in such a manner so as to provide contrast without using power.

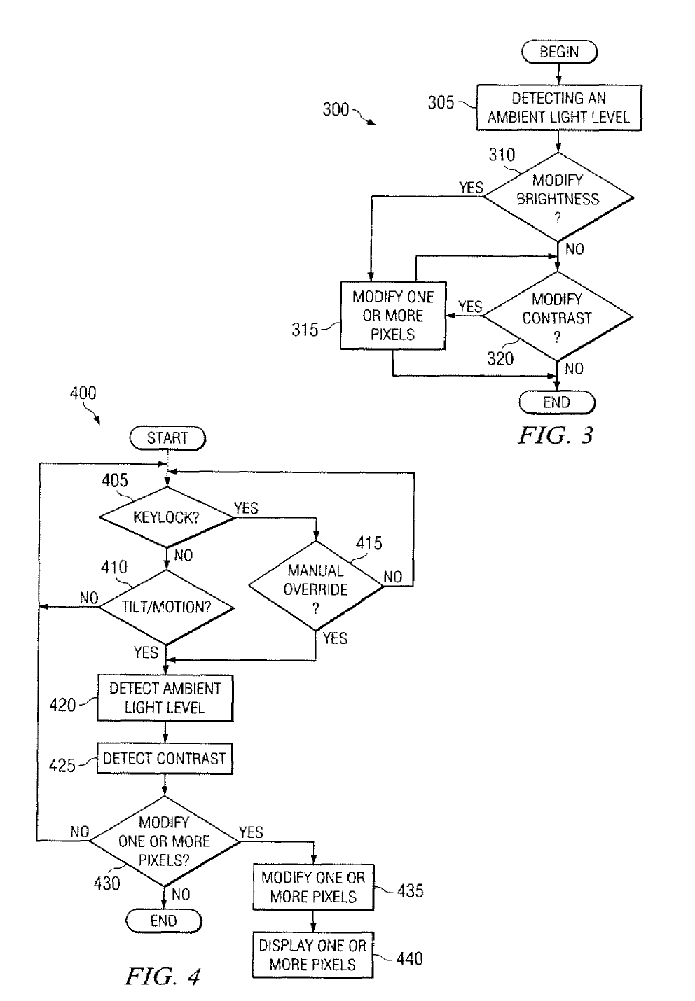

FIG. 3 is a flow diagram illustrating an example method 300 for modifying one or more pixels in accordance with an example embodiment of the invention. Example method 300 may be performed by an electronic device, such as electronic device 100 of FIGURE 1 or FIG. 2.

At 305, an ambient light level is detected. In an example embodiment, one or more ambient light sensors, such as one or more ambient light sensors 215 of FIG. 2, detect the ambient light level, e.g., amount of light in an environment of, for example, for a display, such as display 205 of FIG. 2. In an embodiment, the one or more ambient light sensors are based at least in part on one of photoresistors, photodiodes, phototransistors, and/or the like. In an embodiment, the one or more ambient light sensors are used to determine at what level the pixels of the transparent display should be illuminated. In lower light levels the illumination of the pixels could be reduced thus contributing to power saving.

At 310, it is determined whether the brightness is to be modified. In an example embodiment, the electronic device determines whether the detected ambient light level is at an appropriate brightness level. For example, the electronic device determines if the ambient light level is too bright or dark.

If at 310 it is determined that the brightness is to be modified, then at 315, one or more pixels are modified. In an example embodiment, the display and/or electronic device displays the pixels to modify the brightness on the display. For example, the display and/or electronic device display pixels to brighten or darken the color of the display. The example method 300 continues at 315.

If at 310 it is determined that the brightness is not to be modified, then at 320, it is determined whether the contrast is to be modified. In an example embodiment, one or more color sensors, such as one or more color sensors 210 of FIG. 2, are used to determine whether contrast between the illuminated pixels on the display and the background, e.g., behind the display should be modified. For example, the display and/or electronic device determine whether the determined contrast has an appropriate contrast to the displayed pixel color.

If at 320 it is determined that the contrast is to be modified, then at 315, one or more pixels are modified. In an example embodiment, the display and/or electronic device displays the pixels to modify the contrast on the display. For example, the display and/or electronic device display pixels to adjust coloring in a portion of the display. The example method 300 ends.

If at 320 it is determined that the contrast is not to be modified, then the example method 300 ends.

FIG. 4 is a flow diagram illustrating an example method 400 for displaying one or more pixels in accordance with an example embodiment of the invention. Example method 400 may be performed by an electronic device, such as electronic device 100 of FIGURE 1 or FIG. 2.

At 405, it is determined whether a keylock entry is performed. In an example embodiment, a processor of the electronic device determines the keylock entry. For example, the processor determines a user is accessing the phone.

If at 405 it is determined a keylock entry is not performed, then at 410, it is determined whether there is a tilt or motion. In an example embodiment, the processor determines whether the electronic device has been tilted or moved. For example, the processor detects a user changing the position of the electronic device.

If at 410 it is determined that there is a tilt or motion, the example method 400 continues at 420. If at 410 it is determined that there is no tilt or motion, the example method 400 continues at 405.

If at 405 it is determined that a keylock entry is performed, then at 415 it is determined whether there is a manual override. In an example embodiment, the processor determines whether the electronic device should be accessed based on the manual override.

If at 415 it is determined that there is no manual override, the example method continues at 405.

If at 415 it is determined that there is a manual override, then at 420, ambient light level is detected. In an example embodiment, an ambient light sensor, such as the one or more ambient light sensors 215 of FIG. 2, determines whether the detected ambient light level is at an appropriate brightness level. For example, the electronic device determines if the ambient light level is too bright or dark.

At 425, contrast is detected. In an example embodiment, the display and/or electronic device displays the pixels to modify the contrast on the display. For example, the display and/or electronic device display pixels to adjust coloring in a portion of the display. The example method 300 ends.

If at 430 it is determined whether one or more pixels are to be modified. In an example embodiment, the display and/or electronic device determine whether the pixels are to be modified based at least in part on the detected ambient light level and detected contrast. A technical effect of one or more of the example embodiments disclosed herein is modifying one or more pixels to modify contrast. Another technical effect of one or more of the example embodiments disclosed herein is modifying one or more pixels to modify brightness.

If at 430 it is determined that one or more pixels are to be modified, then at 435, the one or more pixels are modified. In an example embodiment, the display and/or electronic device modifies the one or more pixels. For example, the display and/or electronic device modify the one or more pixels to brighten or darken the color of the display.

At 440, the one or more pixels are displayed. In an example embodiment, the display of the electronic device displays the one or more modified pixels. For example, the display displays the one or more pixels to adjust brightness or contrast. The example method 400 ends.

If at 430 it is determined that one or more pixels are not to be modified, then the example method 400 ends.

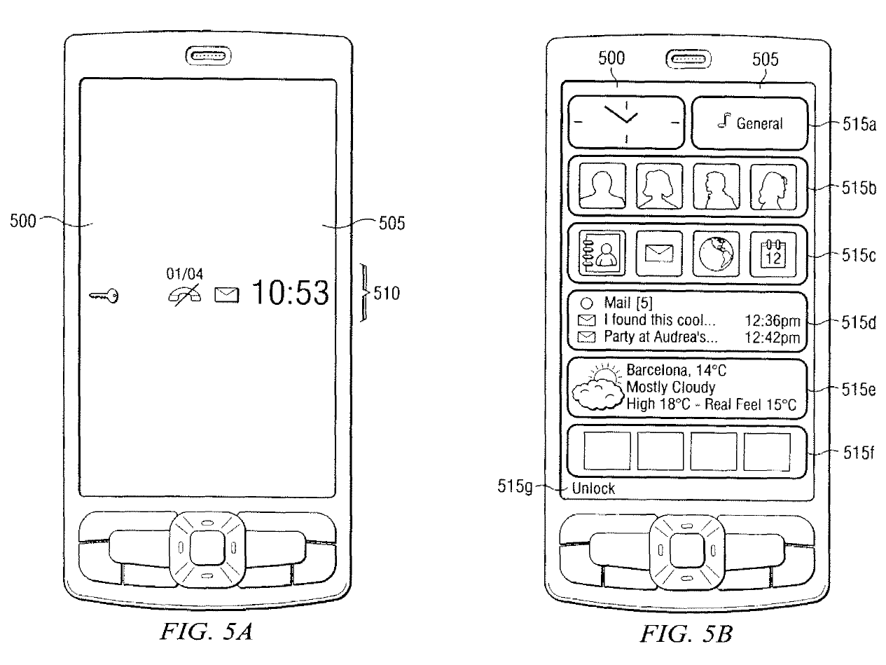

FIG. 5A is a block diagram depicting an example display 500 in accordance with an example embodiment of the invention. In an example embodiment, an example display 500 comprises a transparent background 505 and one or more pixels 510. The example display 500 provides a user with one or more pixels 510 representing a date and time, among other information, in a color darker than the transparent background 505. Stated differently, the one or more pixels 510 provide an appropriate contrast and/or brightness based on the modification of the one or more pixels 510 in view of the transparent background 505 color and/or ambient light level.

FIG. 5B is a block diagram depicting another example display 500 in accordance with an example embodiment of the invention. In an example embodiment, an example display 500 comprises a transparent background 505 and one or more pixels 515a-g. In this example embodiment, the display 500 employing embodiments of the invention modifies and displays one or more pixels 515a-g to provide a user with a working display while using the transparent background 505 to conserve power, e.g., not displaying a color, but rather use the transparent background 505 color and modify pixels on top of the transparent background 505 to provide contrast.

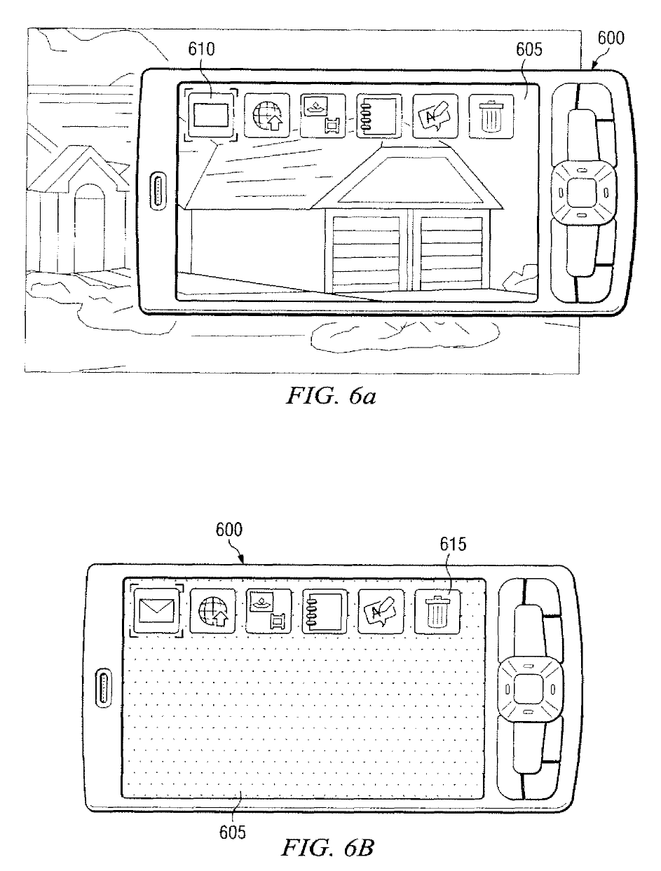

FIG. 6A is a block diagram depicting yet another example display 600 in accordance with an example embodiment of the invention. FIG. 6B is a block diagram depicting still another example display 600 in accordance with an example embodiment of the invention. FIGS. 6A-6B provide an example display 600 comprising a transparent background 605 and one or more modified pixels 610 and 615. In such examples, the transparent display 600 comprises one or more modified pixels 610 and 615 in which are turned off so as to display the background. By employing embodiments of the invention, the one or more pixels 610 and 615 may be modified to display in an appropriate contrast and ambient light level given the transparent background 605.

Without in any way limiting the scope, interpretation, or application of the claims appearing below, a technical effect of one or more of the example embodiments disclosed herein is modifying one or more pixels to modify contrast. Another technical effect of one or more of the example embodiments disclosed herein is modifying one or more pixels to modify brightness.

Embodiments of the present invention may be implemented in software, hardware, application logic or a combination of software, hardware and application logic. The software, application logic and/or hardware may reside on an electronic device or a computer. If desired, part of the software, application logic and/or hardware may reside on an electronic device and part of the software, application logic and/or hardware may reside on a computer. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
the apparatus configured to:
detect an ambient light level; and
modify one or more pixels to display in a power conserving manner based at least in part on the ambient light level.

2. The apparatus of claim 1 further comprising a transparent display to detect an ambient light level.

3. The apparatus of claim 2 wherein the ambient light level is related to the apparatus.

4. The apparatus of claim 1 wherein the apparatus is further configured to illuminate or un-illuminate the one or more pixels based at least in part on a contrast.

5. The apparatus of claim 3 wherein the transparent color is presented in such a manner so as to provide contrast without using power.

6. The apparatus of claim 1 wherein the apparatus comprises a transparent organic light-emitting diode display.

7. The apparatus of claim 1 wherein the apparatus uses one or more ambient light sensors to modify brightness.

8. The apparatus of claim 7 wherein the one or more ambient light sensors uses at least one of: photoresistors, photodiodes, and phototransistors.

9. The apparatus of claim 1 wherein the apparatus further comprises one or more color sensor to adjust contrast.

10. A method, comprising:
detecting an ambient light level; and
modifying one or more pixels to display in a power conserving manner based at least in part on the ambient light level.

11. The method of claim 10 wherein detecting an ambient light level uses a transparent display.

12. The method of claim 11 wherein the ambient light level is related to the apparatus.

13. The method of claim 10 further comprising illuminating or un-illuminating the one or more pixels based at least in part on a contrast.

14. The method of claim 12 further comprising presenting the transparent color in such a manner so as to provide contrast without using power.

15. The method of claim 10 wherein detecting an ambient light level uses a transparent organic light-emitting diode display.

16. The method of claim 10 further comprising modifying brightness using one or more ambient light sensors to modify brightness.

17. The method of claim 16 wherein the one or more ambient light sensors uses at least one of: photoresistors, photodiodes, and phototransistors.

18. The method of claim 10 further comprising adjusting contrast using one or more color sensors.

19. A computer program product comprising a computer-readable medium bearing computer program code embodied therein for use with a computer, the computer program code comprising:
code for detecting an ambient light level; and
code for modifying one or more pixels to display in a power conserving manner based at least in part on the ambient light level.

20. The computer program product of claim 19 further comprising code for detecting an ambient light level uses a transparent organic light-emitting diode display.
